(19) United States
(12) Patent Application Publication
(10) Pub. No.: US 2014/0279494 A1
(43) Pub. Date: Sep. 18, 2014

(54) METHOD AND SYSTEM OF DETECTING AND USING GEOFENCING FOR FRAUD DETECTION AND MODELING

(71) Applicant: MASTERCARD INTERNATIONAL INCORPORATED, Purchase, NY (US)

(72) Inventors: Mark WIESMAN, Chesterfield, MO (US); Theunis Johannes GERBER, Wildwood, MO (US); Susan Marie MEYER, St. Charles, MO (US)

(73) Assignee: MasterCard International Incorporated, Purchase, NY (US)

(21) Appl. No.: 13/795,169

(22) Filed: Mar. 12, 2013

(51) Int. Cl. G06Q 20/32

(52) U.S. Cl. CPC G06Q 20/3224
USPC 705/44; 705/39

(57) ABSTRACT

A method for identifying fraud factors includes: storing data points; storing financial transactions; storing a plurality of consumer data entries, each data entry associated with a consumer and including a mobile device identifier and account identifier; identifying a home market for a data entry based on usage patterns of an associated financial account; identifying, at a predetermined time, a geographic location of a mobile device associated with the data entry; storing a location data point for the geographic location if the geographic location is outside of a predetermined distance from the home market, wherein the location data point includes the identified geographic location, the consumer associated with the data entry, and a time and/or date at which the geographic location was identified; and identifying a fraud factor for detecting fraud in a transaction, the fraud factor based on the financial transactions, the data points, and the location data point.

### FIELD

The present disclosure relates to the use of geofences to identify fraud factors, specifically using home markets and geolocation to identify when a consumer is outside of a home market to identify fraud factors to provide additional account security.

### BACKGROUND

When a fraudulent financial transaction occurs using a payment account, such as a credit card account, it can often cause harm to not only the account holder, but also to the merchant involved in the financial transaction and the issuer of the payment account. As such, many issuers offer services to their customers to help prevent fraud or to more quickly identify when a fraudulent transaction occurs, in order to remedy the situation. Many merchants also take measures to try and prevent such fraudulent transactions from taking place. In one such solution, issuers deny authorization for financial transactions when a transaction originates in a different state than the one where the account holder is based.

However, such solutions may often not account for consumers who regularly travel, live near state or municipal borders, or have multiple residences. In these instances, a consumer may have to repeatedly contact their issuer when moving locations or may have to make special arrangements, such as having a separate payment account in each location. Accordingly, current systems and methods for identifying fraud factors, rules, and models are unsuitable for these types of consumers.

Thus, there is a need for a technical solution to improve the identification of fraud factors for consumers based on home markets and consumer geographic locations.

### SUMMARY

The present disclosure provides a description of a systems and methods for the identification of fraud factors by detecting and using geofences.

A method for identifying fraud factors includes: storing, in a fraud database, a plurality of data points; storing, in a transaction database, a plurality of financial transactions; storing, in a consumer database, a plurality of consumer data entries, wherein each consumer data entry is associated with a consumer and includes at least a mobile device identifier and an account identifier; identifying, by a processing device, at least one home market for each consumer data entry in the plurality of consumer data entries based on usage patterns of a financial account associated with the account identifier; associating, in the consumer database, the identified at least one home market with the corresponding consumer data entry; identifying, at a predetermined time, a geographic location of a mobile device associated with the mobile device identifier for each consumer data entry; storing, in the fraud database, a location data point for each identified geographic location if the identified geographic location is outside of a predetermined distance from the at least one home market associated with the corresponding consumer data entry, wherein the location data point includes at least the identified geographic location, the consumer associated with the corresponding consumer data entry, and a time and/or date at which the geographic location was identified; and identifying, by the processing device, at least one fraud factor for detecting fraud in a financial transaction, wherein the at least one fraud factor is based on at least the plurality of financial transactions, the plurality of data points, and each location data point.

Another method for identifying fraud factors includes: storing, in a fraud database, a plurality of data points; storing, in a transaction database, a plurality of financial transactions; storing, in a consumer database, a plurality of consumer data entries, wherein each consumer data entry is associated with a consumer and includes at least a mobile device identifier and at least one home market; transmitting, by a transmitting device, the plurality of consumer data entries; receiving, by a receiving device, a plurality of location data points, wherein each location data point includes at least a mobile device identifier, a geographic location of a mobile device associated with the mobile device identifier, and a time and/or date at which the mobile device is identified as outside of a predetermined distance from the at least one home market associated with the corresponding consumer data entry; and identifying, by a processing device, at least one fraud factor for detecting fraud in a financial transaction, wherein the at least one fraud factor is based on at least the plurality of financial transactions, the plurality of data points, and each location data point.

A system for identifying fraud factors includes a fraud database, a transaction database, a consumer database, and a processing device. The fraud database is configured to store a plurality of data points. The transaction database is configured to store a plurality of financial transactions. The consumer database is configured to store a plurality of consumer data entries, wherein each consumer data entry is associated with a consumer and includes at least a mobile device identifier and an account identifier. The processing device is configured to: identify at least one home market for each consumer data entry in the plurality of consumer data entries based on usage patterns of a financial account associated with the account identifier; associate, in the consumer database, the identified at least one home market with the corresponding consumer data entry; identify, at a predetermined time, a geographic location of a mobile device associated with the mobile device identifier for each consumer data entry; store, in the fraud database, a location data point for each identified geographic location if the identified geographic location is outside of a predetermined distance from the at least one home market associated with the corresponding consumer data entry, wherein the location data point includes at least the identified geographic location, the consumer associated with the corresponding consumer data entry, and a time and/or date at which the geographic location was identified; and identify at least one fraud factor for detecting fraud in a financial transaction, wherein the at least one fraud factor is based on at least the plurality of financial transactions, the plurality of data points, and each location data point.

Another system for identifying fraud factors includes a fraud database, a transaction database, a consumer database, a transmitting device, a receiving device, and a processing device. The fraud database is configured to store a plurality of data points. The transaction database is configured to store a plurality of financial transactions. The consumer database is configured to store a plurality of consumer data entries, wherein each consumer data entry is associated with a consumer and includes at least a mobile device identifier and at least one home market. The transmitting device is configured to transmit the plurality of consumer data entries. The receiving device is configured to receive a plurality of location data points, wherein each location data point includes at least a mobile device identifier, a geographic location of a mobile device associated with the mobile device identifier, and a time and/or date at which the mobile device is identified as outside of a predetermined distance from the at least one home market associated with the corresponding consumer data entry. The processing device is configured to identify at least one fraud factor for detecting fraud in a financial transaction, wherein the at least one fraud factor is based on at least the plurality of financial transactions, the plurality of data points, and each location data point.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level diagram illustrating a system for identifying fraud factors using home markets and geographic locations in accordance with exemplary embodiments.

FIG. 2 is a block diagram illustrating the fraud factor processing server of the system of FIG. 1 in accordance with exemplary embodiments.

FIG. 3 is a block diagram illustrating the consumer database of the fraud factor processing server of FIG. 2 in accordance with exemplary embodiments.

FIG. 4 is a diagram illustrating home markets associated with a consumer in accordance with exemplary embodiments.

FIG. 5 is a diagram illustrating identified geographic locations for consumers used to identify fraud factors in accordance with exemplary embodiments.

FIG. 6 is a flow diagram illustrating a method for identifying location data points for use in identifying fraud factors in accordance with exemplary embodiments.

FIG. 7 is a flow diagram illustrating a method for identifying and applying fraud factors based on location data points in accordance with exemplary embodiments.

FIGS. 8 and 9 are flow charts illustrating exemplary methods for identifying fraud factors in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Generating and Provisioning Payment Credentials

FIG. 1 illustrates a system 100 for the identification of fraud factors using location data points based on home markets and consumer geographic locations. The system 100 may include a fraud factor processing server 102, discussed in more detail below. The fraud factor processing server 102 may be configured to identify home markets for consumers and to identify fraud factors based on consumer home markets and identified geographic locations at predetermined times.

The fraud factor processing server 102 may receive transaction data related to a plurality of financial transactions from a financial transaction processing agency 104. The financial transaction processing agency 104 may operate as or as a part of a payment network, or may be an entity that receives and stores transaction information received from a payment network. The financial transaction processing agency 104 may transmit transaction data to the fraud factor processing server 102. In some embodiments, the transaction data may lack personally identifiable information. In other embodiments, the transaction data may be personally identifiable, but obtained with the consent of the consumer involved in the corresponding financial transaction. The fraud factor processing server 102 may also receive data points from one or more data providers 106. The data points may be points of data associated with a plurality of consumers that are related to information that may be considered in the creation of one or more fraud factors, such as credit information, fraud history, payment account information, etc. Information suitable for use as data points will be apparent to persons having skill in the relevant art. A fraud factor may be a factor identified by the fraud factor processing server 102 that may be used as or as part of a fraud rule or fraud model used to identify the likelihood that a payment transaction may be fraudulent. The use of fraud factors in the creation of fraud rules and/or fraud models and the application thereof to a payment transaction will be apparent to persons having skill in the relevant art.

The fraud factor processing server 102 may store a plurality of consumer data entries in a consumer database, discussed in more detail below, where each consumer data entry is associated with a consumer and includes at least a mobile device identifier and an account identifier. The mobile device identifier may identify a mobile device 108 associated with the consumer. The mobile device 108 may be any type of mobile computing device suitable for performing the functions as disclosed herein, such as a cellular phone, smart phone, tablet computer, etc.

The fraud factor processing server 102 may identify at least one home market (e.g., a geographic region associated with a defined set of activities, or geofence, in this instance associated with a statistical model of transactions within a range of a person's home, that might be set statically, customized to the person or dynamically set according to activities or a person, group or panel of people or a population in general), e.g., for each consumer based on usage patterns of a financial account (e.g., a payment card account) associated with the account identifier included in the corresponding consumer data entry. In some embodiments, the usage patterns may be identified using the transaction history received from the financial transaction processing agency 104. Home markets, discussed in more detail below, may be a geographic area in which the consumer regularly transacts using the financial account. This can be determined by frequency, type of transactions (grocery or home improvement, as examples), statistical models of populations (e.g., people in a city might have a home market of a few blocks of a home address and in the suburb several miles based of statistical models of a panel or the general population, or as determined for a particular individual). In some instances, a consumer may have multiple home markets. For example, a consumer may have a first home market centered on their primary residence, a second home market centered on their place of business, and a third home market centered around a vacation property, or a place of work if they tend to spend regularly in that location.

The system 100 may further include a location identifying agency 112. The location identifying agency 112 may be configured to identify a geographic location of the mobile device 108 or by the mobile device self-reporting its location (e.g., at the consent of the user of the mobile device 108). Methods for identifying a geographic location of a mobile device will be apparent to persons having skill in the relevant art, such as using the global positioning system. In some embodiments, the location identifying agency 112 may identify the geographic location at a predetermined time or at predetermined time intervals. For example, the location identifying agency 112 may identify the geographic location of the mobile device 108 every four hours, or at set times throughout the day. In such an instance, the identification of the geographic location of a plurality of mobile devices may be performed using less bandwidth and resources, while still providing an adequate sample of data.

The location identifying agency 112 may transmit the identified geographic location of the mobile device 108 to the fraud factor processing server 102. The fraud factor processing server 102 may then compare the identified geographic location with the identified at least one home market of the consumer corresponding to the mobile device 108 to determine if the mobile device 108, and therefore consumer, were outside of their home market(s). If the geographic location was outside of each home market, then the fraud factor processing server 102 may identify (e.g., generate) a location data point including the geographic location, the consumer, and a time and/or date at which the geographic location was identified and store the identified location data point in a fraud database.

The fraud factor processing server 102 may then identifying at least one fraud factor for detecting fraud in a payment transaction, where the at least one fraud factor is based on at least the plurality of financial transactions involving the consumer, the plurality of data points involving the consumer, and each identified location data point. In some embodiments, the fraud factor processing server 102 may further identify a fraud rule and/or a fraud model based on at least the identified at least one fraud factor.

The identified fraud factor may be used to assist in the identification of fraudulent transactions. For example, the consumer corresponding to the mobile device 108 may initiate a payment transaction with a merchant 110. The merchant 110 may be located outside of a home market of the consumer. The merchant 110 may submit an authorization request for the payment transaction to the financial transaction processing agency 104 for processing using systems and methods apparent to persons having skill in the relevant art. The financial transaction processing agency 104 may transmit relevant transaction information to the fraud factor processing server 102. The fraud factor processing server 102 may then identify a fraud score for the payment transaction based on the transaction information and identified fraud factor (e.g., and/or identified fraud rule or model) indicating the likelihood that the transaction is fraudulent, and may return the score to the financial transaction processing agency 104. The financial transaction processing agency 104 (e.g., or an issuer of a payment account used in the financial transaction) may then use the score to determine if the transaction should be authorized.

In the present example, the fraud factor may identify a score indicating that the transaction is not fraudulent based on identified location data points. The fraud factor processing server 102 may have identified location data points showing that the mobile device 108 associated with the consumer was outside of their home market and at or near the same geographic location as the merchant 110 at around the same time for each of the last three days, and that the geographic location is near a main road connecting their residence home market with their place of business home market. In such an instance, the fraud factor processing server 102 may identify a low likelihood of a fraudulent transaction as the data indicates the consumer has simply started to stop and shop at the merchant 110 regularly on their way to or from work.

### Fraud Factor Processing Server

FIG. 2 illustrates an embodiment of the fraud factor processing server 102 of the system 100. It will be apparent to persons having skill in the relevant art that the embodiment of the fraud factor processing server 102 illustrated in FIG. 2 is provided as illustration only and may not be exhaustive to all possible configurations of the fraud factor processing server 102 suitable for performing the functions as discussed herein. For example, the computer system 1000 illustrated in FIG. 10 and discussed in more detail below may be a suitable configuration of the fraud factor processing server 102.

The fraud factor processing server 102 may include at least a receiving unit 202, a processing unit 204, a transaction database 206, a fraud database 208, a consumer database 210, and a transmitting unit 212. The receiving unit 202 may be configured to receive transaction data for a plurality of financial transactions. The processing unit 204 may store the received transaction data in the transaction database 206. The transaction data may include any information suitable for performing the functions as disclosed herein as will be apparent to persons having skill in the relevant art. For example, the transaction data may include information identifying the consumer involved in the financial transaction (e.g., at the consent of the consumer), time and/or date information, and merchant identifying information and/or geographic location identifying information.

The receiving unit 202 may also be configured to receive data points from one or more data providers 106, such as a credit bureau. The processing unit 204 may store the received data points in the fraud database 208. The processing unit 204 may also be configured to store, in the consumer database 210, a plurality of consumer data entries, wherein each consumer data entry is related to a consumer. The consumer database 210 and consumer data entries are discussed in more detail below. In some embodiments, the receiving unit 202 may receive consumer information, such as a mobile device identifier, from which consumer data entries may be created and stored. For example, a consumer may register with the fraud factor processing server 102 (e.g., or be registered via an issuer) and provide a mobile device identifier.

The processing unit 204 may be further configured to identify, for each consumer data entry, at least one home market based on usage patterns of a financial account associated with the consumer for each corresponding consumer data entry. Home markets are discussed in more detail below. The receiving unit 202 may also be configured to receive geographic location information, such as from the location identifying agency 112. The processing unit 204 may be configured to store, in the fraud database 208, a location data point for each received geographic location if the received geographic location is outside of the home market(s) for the corresponding consumer as stored in the consumer data entry. The location data point may further include the corresponding consumer and a time and/or date at which the geographic location was identified.

The processing unit 204 may be further configured to identify at least one fraud factor for detecting fraud in a financial transaction based on the information included in the transaction database 206 and the fraud database 208. In some embodiments, the processing unit 204 may be further configured to identify and/or generate at least one fraud rule or fraud model including the identified at least one fraud factor.

In one embodiment, the transmitting unit 212 may be configured to transmit the consumer data entries to the location identifying agency 112. In such an embodiment, the location identifying agency 112 may identify location data points where the mobile device 108 associated with each consumer corresponding to a consumer data entry is identified at a geographic location outside of the associated home market(s). The location identifying agency 112 may then transmit the identified location data points to the fraud factor processing server 102 to be received by the receiving unit 202, and then stored in the fraud database 208 by the processing unit 204.

In some embodiments, the fraud factor processing server 102 may operate as part of or in conjunction with a payment network, such as one including the financial transaction processing agency 104. In one such embodiment, the receiving unit 202 may receive transaction information for a payment transaction, the processing unit 204 may identify a fraud score for the payment transaction based on the identified at least one fraud factor, and the transmitting unit 212 may transmit a response including the identified fraud score.

In another such embodiment, the receiving unit 202 may receive an authorization request for a payment transaction, wherein the authorization request includes transaction information. The processing unit 204 may identify a fraud score for the payment transaction based on at least the transaction information and identified at least one fraud factor or a fraud rule or model incorporating the at least one fraud factor. The transmitting unit 212 may transmit the fraud score and relevant transaction information to an issuer corresponding to a payment account used to fund the payment transaction, and the receiving unit 202 may receive a response from the issuer indicating approval or denial of the payment transaction. The processing unit 204 may then generate an authorization response, which may be transmitted by the transmitting unit 212 to the originator of the authorization request (e.g., the merchant 110 or an acquirer, such as an acquiring bank).

### Consumer Database and Home Markets

FIG. 3 illustrates the consumer database 210 of the fraud factor processing server 102. The consumer database 210 may store a plurality of consumer data entries 302, illustrated in FIG. 3 as consumer data entries 302a, 302b, and 302c. Each consumer data entry 302 may include at least a mobile device identifier 304, an account identifier 306, a location frequency 308, and at least one home market 310.

The mobile device identifier 304 may be a value suitable for identifying a unique mobile device 108 associated with a consumer corresponding to the consumer data entry 302. Values suitable for use as the mobile device identifier 304 will be apparent to persons having skill in the relevant art and may include, for example, a phone number, a media access control (MAC) address, an internet protocol (IP) number, email address, etc. The account identifier 306 may be a value suitable for identifying a payment account associated with the consumer corresponding to the consumer data entry 302. The account identifier 306 may be, for example, a payment account number (e.g., a credit card number), a username, a phone number, an e-mail address, or any other suitable value as will be apparent to persons having skill in the relevant art.

The locating frequency 308 may be one or more predetermined periods of time at which the geographic location of the mobile device 108 corresponding to the mobile device identifier 304 is to be identified. In some instances, the locating frequency 308 may be a time interval, such as every four hours. In other instances, the locating frequency 308 may be specified recurring times, such as at 8 A.M., noon, 2 P.M., 4 P.M., 6 P.M., and 10 P.M. In some embodiments, the consumer and/or the fraud factor processing server 102 may specify different locating frequencies 308 for different days (e.g., each day of the week, weekends, weekdays, etc.).

The home market 310 (e.g., a home geofence) may be a geographic area where the consumer corresponding to the consumer data entry 302 regularly transacts based on usage patterns for the payment account corresponding to the account identifier 306. FIG. 4 illustrates multiple consumer data entries 302 and the home markets 310 included therein. As illustrated in FIG. 4, in some embodiments a home market 310 may be defined by a center 402, such as the center of a postal code, and may include a market distance 312, which may be a radius or diameter from the center 402 that represents the area covered by the home market 310. The home market 310 may be represented as a circle at the center 402 with a radius of the distance 312, may be a square with the center 402 and the distance 312 being the distance to one side or one corner of the square, etc.

In some embodiments, the home market 310 may be defined as one or more defined geographic areas, such as a postal code, zip code, subdivision, neighborhood, county, city, municipality, etc. In other embodiments, the center 402 may be a street or physical address, a geographic location defined by longitude and latitude, or any other suitable value. In some instances, the home market 310 may be any type of shape defined by discrete points or values (e.g., such as street addresses or geographic coordinates). Suitable methods for determining and defining home markets 310 will be apparent to persons having skill in the relevant art and can be adapted to fit circumstances, business needs, fraud models or rules, or be based on history or statistical studies of the customer, grouped of customers perhaps clustered by home address or other demographic information, somewhat arbitrary, based on population density (urban home markets would likely be geographically smaller than urban markets, for instance), and other factors or considerations, whether commercial, to adjust computer overhead, or any other appropriate factor or consideration.

Some consumer data entries 302 may include multiple home markets 310, such as the consumer data entries 302a and 302b illustrated in FIG. 4. Such an instance may occur when, for example, a consumer regularly transacts nearby their residence as well as near to their place of employment, which may be a significant commute away from their residence. A consumer may also have a home market located at a regular travel destination, or in other instances apparent to persons having skill in the relevant art. In some cases, home markets 310 may be different for specific days of the week, months, seasons, etc. or certain home markets 310 may be active for specific days of the week, months, seasons, etc. For example, a work home market 310 may not be considered a home market for the identification of location data points on weekends.

### Identification of Location Data Points

FIG. 6 illustrates a method 600 for the identification of location data points based on the geographic location of a mobile device 108 compared to one or more home markets 310 corresponding to a consumer associated with the mobile device 108.

In step 602, a mobile device identifier 304 of a consumer data entry 302 may be identified. In step 604, the fraud factor processing server 102 and/or location identifying agency 112 may determine if the current time corresponds to the predetermined time as indicated by the locating frequency 308. If it is not the predetermined time, then, in step 606, the method may continue to wait until the predetermined time is reached. Once it is the predetermined time, then, in step 608, the location identifying agency 112 may locate the mobile device 108 corresponding to the mobile device identifier 304. Suitable methods for locating the mobile device 108 will be apparent to persons having skill in the relevant art.

FIG. 5 illustrates a plurality of location data points 502. As illustrated in FIG. 5, each location data point 502 may include the mobile device identifier 304, a geographic location 504, and a time and/or date 506. The geographic location 504 may be a postal code, street address, geographic coordinate, or any other suitable value. In step 610, the fraud factor processing server 102 or location identifying agency 112 may determine if the geographic location 504 identified in step 608 is located within a home market 310.

If the geographic location 504 is located within a home market 310, then method 600 returns to step 606 and waits for the next predetermined time to locate the mobile device 108. If, on the other hand, the geographic location 504 is not located within a home market 310, then, in step 612, the time and/or date 506 for the location data point 502 is stamped. As illustrated in FIG. 5, in the first location data point 502, the mobile device identifier 304 corresponds to the consumer data entry 302a illustrated in FIG. 4, which includes three home markets 310. The geographic location 504 is not located within the distance 312 to the center 402 of any of the three home markets 310. As a result, the fraud factor processing server 102 stores, in step 614, a the location data point 502 in the fraud database 208 including the mobile device identifier 304, the geographic location 504, and the time and/or date 506 as the mobile device 108 was identified outside of any associated home markets 310 at the stamped time and/or date 506.

### Identification of Fraud Factors

FIG. 7 illustrates a method 700 for the identification, testing, and application of fraud factors based on the identification of location data points 502.

In step 702, the fraud factor processing server 102 may determine if there are any mobile device identifiers 304 that need to have home markets identified. If there are, then, in step 704, the processing unit 204 may identify the next mobile device identifier 304 and identify at least one corresponding home market 310 based on usage patterns of a payment account corresponding to the account identifier 306 included in the corresponding consumer data entry 302. In step 706, the processing unit 204 may associate the identified at least one home market 310 with the mobile device 108 by storing the at least one home market 310 in the consumer data entry 302 including the mobile device identifier 304.

Then, once all mobile device identifiers 304 have been processed (e.g., each mobile device identifier 304 has associated home market(s) 310), in step 708 the consumer data entries 302 may be transmitted to the location identifying agency 112. The location identifying agency 112 may, based on the information included in the consumer data entries 302, identifying a plurality of location data points 502 and may transmit the identified location data points 502 to the fraud factor processing server 102, which may receive the plurality of location data points in step 710. It will be apparent to persons having skill in the relevant art that, in some embodiments, the location identifying agency 112 may provide geographic location information 504 to the fraud factor processing server 102, and the fraud factor processing server 102 may identify the location data points 502 based thereon.

In step 712, the fraud factor processing server 102 may store the plurality of location data points 502 in the fraud database 208. Then, in step 714, the fraud factor processing server 102 may identify and test at least one fraud factor based on transaction information stored in the transaction database 206 and the data points, including location data points, stored in the fraud database 208 associated with each consumer corresponding to each consumer data entry 302. Methods for testing a fraud factor will be apparent to persons having skill in the relevant art and may include, for example, applying the fraud factor to a fraud rule or model and scoring a known fraudulent transaction to determine if the transaction is considered to be fraudulent once the fraud factor is applied.

In step 716, the fraud factor processing server 102 may determine if the fraud factor is suitable based on at least the test performed in step 714. If the fraud factor is not suitable, then the process may return to step 714 where a new or modified fraud factor is identified and tested based on the location data points 502 and additional information as discussed above. If the fraud factor is suitable, then, in step 718, the fraud factor may be used (e.g., as part of a fraud rule or fraud model) in the processing of payment transactions to identify potentially fraudulent transactions. Methods for applying a fraud factor singularly or as part of a fraud rule or fraud model to payment transactions during processing will be apparent to persons having skill in the relevant art.

### First Exemplary Method for Identifying Fraud Factors

FIG. 8 illustrates a method 800 for identifying fraud factors using home markets 310 and location data points 502.

In step 802, a plurality of data points may be stored in a fraud database (e.g., the fraud database 208). In some embodiments, the plurality of data points may include at least one of: credit information, transaction history, fraud history, and financial account information. In step 804, a plurality of financial transactions may be stored in a transaction database (e.g., the transaction database 206). In some embodiments, the plurality of financial transactions may include at least one financial transaction involving the consumer associated with each consumer data entry 302 in the plurality of consumer data entries.

In step 806, a plurality of consumer data entries may be stored in a consumer database (e.g., the consumer database 210), wherein each consumer data entry (e.g., the consumer data entry 302) is associated with a consumer and includes at least a mobile device identifier (e.g., the mobile device identifier 304) and an account identifier (e.g., the account identifier 306). In step 808, at least one home market (e.g., the home market 310) may be identified, by a processing device (e.g., the processing unit 204) for each consumer data entry 302 in the plurality of consumer data entries based on usage patterns for a financial account associated with the account identifier 306. In some embodiments, the financial account associated with the account identifier 306 is a payment card account. In a further embodiment, the usage patterns may include location data for financial transactions funded by a payment card associated with the payment card account. In one embodiment, the at least one home market 310 may be represented by at least one of: a postal code, longitude and latitude, and a street address.

In step 810, the identified at least one home market 310 may be associated, in the consumer database 210, with the corresponding consumer data entry 302. In step 812, a geographic location (e.g., the geographic location 504) may be identified, at a predetermined time, for a mobile device (e.g., the mobile device 108) associated with the mobile device identifier 304 for each consumer data entry 302. In one embodiment, the geographic location 504 may be represented using longitude and latitude. In some embodiments, each consumer data entry 302 may further include at least a checking time, wherein the predetermined time is the checking time for the corresponding consumer data entry 302.

In step 814, a location data point (e.g., the location data point 502) may be stored, in the fraud database 208, for each identified geographic location 504 if the identified geographic location 504 is outside of a predetermined distance (e.g., the market distance 512) from the at least one home market 310 associated with the corresponding consumer data entry 302, wherein the location data point 502 includes at least the identified geographic location 504, the consumer associated with the corresponding consumer data entry 302, and a time and/or date (e.g., the time and/or date 506) at which the geographic location 504 was identified. In one embodiment, identifying the at least one home market 310 may further include identifying a market distance (e.g., the market distance 312) associated with the at least one home market 310, wherein the predetermined distance is the associated market distance 312.

In step 816, at least one fraud factor for detecting fraud in a financial transaction may be identified, by the processing device 204, wherein the at least one fraud factor is based on at least the plurality of financial transactions, the plurality of data points, and each location data point 502. In one embodiment, the method 800 may further include: receiving, by a receiving device (e.g., the receiving unit 202), transaction information for a financial transaction; identifying, by the processing device 204, a fraud score based on the transaction information and the at least one fraud factor; and transmitting, by a transmitting device (e.g., the transmitting unit 212), the identified fraud score.

In some embodiments, the method 800 may be used as part of a method for processing a financial transaction. In such a method, an authorization request for a financial transaction may be received by the receiving device 202, wherein the authorization request includes transaction information. A fraud score may be identified for the financial transaction based on the transaction information and at least one fraud factor, wherein the fraud factor is identified using the method 800. The transaction information and identified fraud score may be transmitted to an issuer, and then an indication of approval of the financial transaction may be received by the receiving device 202. The processing device 204 may then process the financial transaction, which may include transmitting an authorization response message.

### Second Exemplary Method for Identifying Fraud Factors

FIG. 9 illustrates a method 900 for identifying fraud factors using home markets 310 and location data points 502.

In step 902, a plurality of data points may be stored in a fraud database (e.g., the fraud database 208). In one embodiment, the plurality of data points may include at least one of: credit information, transaction history, fraud history, and financial account information. In step 904, a plurality of financial transactions may be stored in a transaction database (e.g., the transaction database 206). In one embodiment, the plurality of financial transactions may include at least one financial transaction involving the consumer associated with each consumer data entry 302 in the plurality of consumer data entries.

In step 906, a plurality of consumer data entries may be stored in a consumer database (e.g., the consumer database 210), wherein each consumer data entry (e.g., the consumer data entry 302) is associated with a consumer and includes at least a mobile device identifier (e.g., the mobile device identifier 304) and at least one home market (e.g., the home market 310). In one embodiment, each of the at least one home market 310 may be represented by at least one of: a postal code, longitude and latitude, and a street address.

In step 908, a transmitting device (e.g., the transmitting unit 212) may transmit the plurality of consumer data entries.

In step 910, a plurality of location data points may be received by a receiving device (e.g., the receiving unit 202), wherein each location data point (e.g., the location data point 502) includes at least a mobile device identifier 304, a geographic location (e.g., the geographic location 504) of a mobile device (e.g., the mobile device 108) associated with the mobile device identifier 304, and a time and/or date (e.g., the time and/or date 506) at which the mobile device 108 is identified as outside of a predetermined distance from the at least one home market 310 associated with the corresponding consumer data entry. In one embodiment, the geographic location may be represented using longitude and latitude. In some embodiments, each of the at least one home market 310 may be associated with a market distance (e.g., the market distance 312), and the predetermined distance may be the associated market distance 312.

In step 912, at least one fraud factor for detecting fraud in a financial transaction may be identified by the processing device 204, wherein the at least one fraud factor is based on at least the plurality of financial transactions, the plurality of data points, and each location data point 502. In one embodiment, the method 900 may further include: receiving, by the receiving device 202, transaction information for a financial transaction; identifying, by the processing device 204, a fraud score based on the transaction information and the identified at least one fraud factor; and transmitting, by the transmitting device 212, the identified fraud score.

In some embodiments, the method 900 may be used as part of a method for processing a financial transaction. In such a method, an authorization request for a financial transaction may be received by the receiving device 202, wherein the authorization request includes transaction information. A fraud score may be identified for the financial transaction based on the transaction information and at least one fraud factor, wherein the fraud factor is identified using the method 900. The transaction information and identified fraud score may be transmitted to an issuer, and then an indication of approval of the financial transaction may be received by the receiving device 202. The processing device 204 may then process the financial transaction, which may include transmitting an authorization response message.

### Computer System Architecture

FIG. 10 illustrates a computer system 1000 in which embodiments of the present disclosure, or portions thereof, may be implemented as computer-readable code. For example, the fraud factor processing server 102, the financial transaction processing agency 104, the data provider 106, the mobile device 108, the merchant 110, and the location identifying agency 112 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communication infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive, the removable storage unit 1018 may be a floppy disk. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

Computer program medium and computer usable medium may refer to memories, such as the main memory 1008 and secondary memory 1010, which may be memory semiconductors (e.g. DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 6-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for the identification of fraud factors. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying fraud factors, comprising:
storing, in a fraud database, a plurality of data points;
storing, in a transaction database, a plurality of financial transactions;
storing, in a consumer database, a plurality of consumer data entries, wherein each consumer data entry is associated with a consumer and includes at least a mobile device identifier and an account identifier;
identifying, by a processing device, at least one home market for each consumer data entry in the plurality of consumer data entries based on usage patterns of a financial account associated with the account identifier;
associating, in the consumer database, the identified at least one home market with the corresponding consumer data entry;
identifying, at a predetermined time, a geographic location of a mobile device 108 associated with the mobile device identifier for each consumer data entry;
storing, in the fraud database, a location data point for each identified geographic location if the identified geographic location is outside of a predetermined distance from the at least one home market associated with the corresponding consumer data entry, wherein the location data point includes at least the identified geographic location, the consumer associated with the corresponding consumer data entry, and a time and/or date at which the geographic location was identified; and
identifying, by the processing device, at least one fraud factor for detecting fraud in a financial transaction, wherein the at least one fraud factor is based on at least the plurality of financial transactions, the plurality of data points, and each location data point.

2. The method of claim 1, wherein the plurality of data points includes at least one of: credit information, transaction history, fraud history, and financial account information.

3. The method of claim 1, wherein the plurality of financial transactions includes at least one financial transaction involving the consumer associated with each consumer data entry in the plurality of consumer data entries.

4. The method of claim 1, wherein the financial account associated with the account identifier is a payment card account.

5. The method of claim 4, wherein the usage patterns include location data for financial transactions funded by a payment card associated with the payment card account.

6. The method of claim 1, wherein the geographic location is represented using longitude and latitude.

7. The method of claim 1, wherein each consumer data entry further includes at least a checking time, and wherein the predetermined time is the checking time for the corresponding consumer data entry.

8. The method of claim 1, wherein the at least one home market is represented by at least one of: a postal code, longitude and latitude, and a street address.

9. The method of claim 1, wherein identifying at least one home market further includes identifying a market distance associated with the at least one home market, and wherein the predetermined distance is the associated market distance.

10. The method of claim 1, further comprising:
receiving, by a receiving device, transaction information for a financial transaction;
identifying, by the processing device, a fraud score based on the transaction information and the identified at least one fraud factor; and
transmitting, by a transmitting device, the identified fraud score.

11. A method for processing a financial transaction, comprising:
receiving, by a receiving device, an authorization request for a financial transaction, wherein the authorization request includes transaction information;
identifying a fraud score for the financial transaction based on the transaction information and at least one fraud factor;
transmitting, to an issuer, the transaction information and identified fraud score;
receiving, by the receiving device, an indication of approval of the financial transaction; and
processing, by a processing device, the financial transaction, wherein processing the financial transaction includes at least transmitting an authorization response message,
wherein the at least one fraud factor is identified using the method of claim 1.

12. A method for identifying fraud factors, comprising:
storing, in a fraud database, a plurality of data points;
storing, in a transaction database, a plurality of financial transactions;
storing, in a consumer database, a plurality of consumer data entries, wherein each consumer data entry is associated with a consumer and includes at least a mobile device identifier and at least one home market;
transmitting, by a transmitting device, the plurality of consumer data entries;
receiving, by a receiving device, a plurality of location data points, wherein each location data point includes at least a mobile device identifier, a geographic location of a mobile device associated with the mobile device identifier, and a time and/or date at which the mobile device is identified as outside of a predetermined distance from the at least one home market associated with the corresponding consumer data entry; and
identifying, by a processing device, at least one fraud factor for detecting fraud in a financial transaction, wherein the at least one fraud factor is based on at least the plurality of financial transactions, the plurality of data points, and each location data point.

13. The method of claim 12, wherein the plurality of data points includes at least one of: credit information, transaction history, fraud history, and financial account information.

14. The method of claim 12, wherein the plurality of financial transactions includes at least one financial transaction involving the consumer associated with each consumer data entry in the plurality of consumer data entries.

15. The method of claim 12, wherein the geographic location is represented using longitude and latitude.

16. The method of claim 12, wherein the at least one home market is represented by at least one of: a postal code, longitude and latitude, and a street address.

17. The method of claim 12, wherein each of the at least one home market is associated with a market distance, and wherein the predetermined distance is the associated market distance.

18. The method of claim 12, further comprising:
receiving, by a receiving device, transaction information for a financial transaction;
identifying, by the processing device, a fraud score based on the transaction information and the identified at least one fraud factor; and
transmitting, by a transmitting device, the identified fraud score.

19. A method for processing a financial transaction, comprising:
receiving, by the receiving device, an authorization request for a financial transaction, wherein the authorization request includes transaction information;
identifying a fraud score for the financial transaction based on the transaction information and at least one fraud factor;
transmitting, to an issuer, the transaction information and identified fraud score;
receiving, by the receiving device, an indication of approval of the financial transaction; and
processing, by the processing device, the financial transaction, wherein processing the financial transaction includes at least transmitting an authorization response message,
wherein the at least one fraud factor is identified using the method of claim 12.

20. A system for identifying fraud factors, comprising:
a fraud database configured to store a plurality of data points;
a transaction database configured to store a plurality of financial transactions;
a consumer database configured to store a plurality of consumer data entries, wherein each consumer data entry is associated with a consumer and includes at least a mobile device identifier and an account identifier;
and a processing device configured to
identify at least one home market for each consumer data entry in the plurality of consumer data entries based on usage patterns of a financial account associated with the account identifier,
associate, in the consumer database, the identified at least one home market with the corresponding consumer data entry,
identify, at a predetermined time, a geographic location of a mobile device associated with the mobile device identifier for each consumer data entry,
store, in the fraud database, a location data point for each identified geographic location if the identified geographic location is outside of a predetermined distance from the at least one home market associated with the corresponding consumer data entry, wherein the location data point includes at least the identified geographic location, the consumer associated with the corresponding consumer data entry, and a time and/or date at which the geographic location was identified, and
identify at least one fraud factor for detecting fraud in a financial transaction, wherein the at least one fraud factor is based on at least a plurality of financial transactions, the plurality of data points, and each location data point.

21. The system of claim 20, wherein the plurality of data points includes at least one of: credit information, transaction history, fraud history, and financial account information.

22. The system of claim 20, wherein the plurality of financial transactions includes at least one financial transaction involving the consumer associated with each consumer data entry in the plurality of consumer data entries.

23. The system of claim 20, wherein the financial account associated with the account identifier is a payment card account.

24. The system of claim 23, wherein the usage patterns include location data for financial transactions funded by a payment card associated with the payment card account.

25. The system of claim 20, wherein the geographic location is represented using longitude and latitude.

26. The system of claim 20, wherein each consumer data entry further includes at least a checking time, and wherein the predetermined time is the checking time for the corresponding consumer data entry.

27. The system of claim 20, wherein the at least one home market is represented by at least one of: a postal code, longitude and latitude, and a street address.

28. The system of claim 20, wherein identifying at least one home market further includes identifying a market distance associated with the at least one home market, and wherein the predetermined distance is the associated market distance.

29. The system of claim 20, further comprising:
a receiving device configured to receive transaction information for a financial transaction; and
a transmitting device configured to transmit a fraud score,
wherein the fraud score is identified by the processing device and is based on at least the transaction information and the identified at least one fraud factor.

30. The system of claim 20, further comprising:
a receiving device configured to receive an authorization request for a financial transaction, wherein the authorization request includes transaction information;
a transmitting device configured to transmit, to an issuer, the transaction information and a fraud score for the financial transaction, wherein
the processing device is further configured to identify the fraud score for the financial transaction based on the transaction information and at least one fraud factor,
the receiving device is further configured to receive an indication of approval of the financial transaction, and
the processing device is further configured to process the financial transaction, wherein processing the financial transaction includes at least causing the transmitting device to transmit an authorization response message.

31. A system for identifying fraud factors, comprising:
a fraud database configured to store a plurality of data points;
a transaction database configured to store a plurality of financial transactions;
a consumer database configured to store a plurality of consumer data entries, wherein each consumer data entry is associated with a consumer and includes at least a mobile device identifier and at least one home market;
a transmitting device configured to transmit the plurality of consumer data entries;
a receiving device configured to receive a plurality of location data points, wherein each location data point includes a mobile device identifier, a geographic location of a mobile device associated with the mobile device identifier, and a time and/or date at which the mobile device is identified as outside of a predetermined distance from the at least one home market associated with corresponding consumer data entry; and
a processing device configured to identify at least one fraud factor for detecting fraud in a financial transaction, wherein the at least one fraud factor is based on at least the plurality of financial transactions, the plurality of data points, and each location data point.

32. The system of claim 31, wherein the plurality of data points includes at least one of: credit information, transaction history, fraud history, and financial account information.

33. The system of claim 31, wherein the plurality of financial transactions includes at least one financial transaction involving the consumer associated with each consumer data entry in the plurality of consumer data entries.

34. The system of claim 31, wherein the geographic location is represented using longitude and latitude.

35. The system of claim 31, wherein the at least one home market is represented by at least one of: a postal code, longitude and latitude, and a street address.

36. The system of claim 31, wherein each of the at least one home market is associated with a market distance, and wherein the predetermined distance is the associated market distance.

37. The system of claim 31, wherein
the receiving device is further configured to receive transaction information for a financial transaction;
the processing device is further configured to identify a fraud score based on the transaction information and the identified at least one fraud factor; and
the transmitting device is further configured to transmit the identified fraud score.

38. The system of claim 31, wherein
the receiving device is further configured to receive an authorization request for a financial transaction, wherein the authorization request includes transaction information;
the processing device is further configured to identify a fraud score for the financial transaction based on the transaction information and the identified at least one fraud factor;
the transmitting device is further configured to transmit, to an issuer, the transaction information and identified fraud score;
the receiving device is further configured to receive an indication of approval of the financial transaction;
and the processing device is further configured to process the financial transaction, wherein processing the financial transaction includes causing the transmitting device to at least transmit an authorization response message.
